(19) United States
(12) Patent Application Publication
(10) Pub. No.: US 2025/0066203 A1
(43) Pub. Date: Feb. 27, 2025

(54) LOW IMPURITY LIGNOCELLULOSIC CARBON

(71) Applicant: INGEVITY SOUTH CAROLINA, LLC, North Charleston, SC (US)

(72) Inventors: Marta Leon Garcia, North Charleston, SC (US); Suvid Joshi, North Charleston, SC (US); James R. Miller, North Charleston, SC (US)

(21) Appl. No.: 18/811,233

(22) Filed: Aug. 21, 2024

Related U.S. Application Data
(60) Provisional application No. 63/520,754, filed on Aug. 21, 2023.

(51) Int. Cl. C01B 32/342; B01J 20/20; B01J 20/28; C01B 32/324; C01B 32/336

(52) U.S. Cl. CPC C01B 32/342; B01J 20/20; B01J 20/28061; B01J 20/28064; B01J 20/28066; C01B 32/324; C01B 32/336; C01P 2006/12

(57) ABSTRACT

Presently described are chemically activated lignocellulosic carbon adsorbent materials comprising high surface area, high microporosity, and low impurities, and methods of making the same. The described structures provide unexpected advantages as compared to currently available materials.

### CROSS-REFERENCE TO RELATED APPLICATIONS

This application claims the benefit of priority to U.S. Provisional Patent Application Ser. No. 63/520,754, filed: 21 Aug. 2023, and titled: Low Impurity Lignocellulosic Carbon, which is incorporated herein by reference in its entirety.

### BACKGROUND

Field of the Discovery. The present disclosure, in various aspects and embodiments, relates to low impurity activated adsorbent materials, and methods of making the same.

Background Information Activated carbons are characterized by a large specific surface area, typically 500-2500 m²/g. Activated carbons can be produced from a variety of raw materials, including, e.g., lignocellulosics such as wood, wood dust, wood flour, cotton linters, coconut shell, fruit pits and stones (e.g., olive pits), nut shells, palm, vegetables such as rice hull or straw; peat; lignite and bituminous coal; pitches; polymers, including synthetic and natural polymers, or a combination thereof.

Typically, carbon is activated using a thermal activation process or a chemical activation process. The thermal activation process commonly uses high temperature and steam and/or treatment with oxidizing gas (e.g., CO₂ or O₂) to carbonize and cat away at the raw material and create porosity. Chemical activation is more commonly done with lignocellulosic raw materials and activation agents such as an acid, strong base or salt (e.g., phosphoric acid, nitric acid, hydrochloric acid, sulfuric acid, potassium hydroxide, sodium hydroxide, potassium carbonate, calcium chloride, zinc chloride). It is typically a lower temperature, higher yield process and often results in activated carbons with a higher surface area than thermally activated carbons.

Two commercially available wood-based, phosphoric acid activated carbons are Nuchar® SA-20 and Nuchar® RGC, both from Ingevity Corporation (North Charleston, South Carolina). These carbons are used in a wide variety of applications, including water treatment for removing of large taste and odor compounds and decolorization of food ingredients, beverages, chemicals, and pharmaceuticals. They have a very high Brunauer-Emmett-Teller (BET) surface area (>1300 m²/g), and relatively large mesopore volume (>60%), which is a great benefit to these applications.

In applications such as odor control that benefit from a more microporous material, thermally activated carbons are often considered. Typical thermally activated coal and coconut carbons have >60% micropores, but a lower BET surface area of <1200 m²/g compared to chemically activated wood-based carbons.

U.S. Pat. Nos. 6,060,424 and 6,043,183 (Westvaco Corp., NY) discuss the ability to control micro and mesoporosity of phosphoric acid activated wood-based carbon for use in carbon double layer capacitor applications. In particular, U.S. Pat. No. 6,060,424 discusses micropore volumes >75%, and U.S. Pat. No. 6,043,183 discusses mesopore volumes >75%, both having high BET surface areas.

Regardless of desired porosity, one obvious outcome of phosphoric acid activation is that the product likely contains some level of residual phosphorus. For example, Ingevity Nuchar®, Norit, and Ceca commercial high surface area activated carbons range from ˜1,600 to 10,000 ppm elemental phosphorus. These levels are not significant for their applications, but there are some applications where activated carbon residual phosphorus levels may be important and desired levels reduced, while still having a high activated carbon BET surface area. In particular, understanding or minimizing phosphorus and other impurity levels in high BET surface area activated carbon may be important in water treatment to minimize eutrophication, and in some electrochemical applications to reduce resistance, improve cycle stability, improve capacity or extend electrode life. This is noted in U.S. Pat. No. 11,688,855.

Thus, there exists a need in the art for high surface area, high microporosity, or high mesoporosity activated carbon materials that are relatively inexpensive to produce but also have low levels of phosphorus and other impurities.

### SUMMARY

Presently described are chemically activated carbon materials formed from lignocellulosic carbon precursor and methods of making the same. The activated lignocellulosic carbon materials surprisingly and unexpectedly demonstrate low levels of impurities, e.g., phosphorus (P), and at least one of high surface area, high microporosity, high mesoporosity or a combination thereof. For those applications, which require low residual P, it would not be obvious to select a phosphoric acid activated carbon.

As such, in an aspect, the disclosure provides a chemically activated lignocellulosic carbon as described herein. In any aspect of embodiment described herein, the chemically activated lignocellulosic carbon is mesoporous or microporous, has reduced impurities as compared to an untreated activated carbon, high surface area.

In any aspect or embodiment described herein, the chemically activated lignocellulosic carbon has a nitrogen BET surface are of at least 1200 m²/g.

In any aspect or embodiment described herein, the chemically activated lignocellulosic carbon is activated by phosphoric acid.

In any aspect or embodiment described herein, the lignocellulosic carbon comprises wood.

In any aspect or embodiment described herein, the chemically activated lignocellulosic carbon comprises a micropore content, based on the total pore volume, of greater than about 50%.

In any aspect or embodiment described herein, the chemically activated lignocellulosic carbon comprises a micropore content, based on the total pore volume, of less than about 50%.

In any aspect or embodiment described herein, the chemically activated lignocellulosic carbon has a phosphorus content of less than about 1000 ppm, 900 ppm, 800 ppm, 700 ppm, 600 ppm, 500 ppm, 400 ppm, 300 ppm, 200 ppm, 100 ppm or less.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 shows general process flow for inventive examples. Lignocellulosic precursor material (e.g., wood-based precursor) is chemically activated with phosphoric acid according to conventional methods (I). For example, the material is blended and heated at a temperature of 450-700° C. for 0.5-3 hours, washed with water and dried to acceptable moisture levels. The product from (I) is then subjected to one or more secondary treatment steps (II) including steam treatment, and optionally treatment with nitrogen/steam blend (with 0-100% steam at 600-900° C.), and optionally an acid washing step. The resulting chemically activated lignocellulosic carbon has desirable micro or mesoporosity, surface area, and reduced impurities, e.g., phosphorus, as compared to the initial activated carbon from (I).

### DETAILED DESCRIPTION

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited. It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether or not the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

Unless otherwise defined, all technical and scientific terms used herein have the same meaning as commonly understood by one of ordinary skill in the art to which this invention belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

Presently described are high surface area, high microporosity or high mesoporosity activated carbon materials formed from chemically activated, e.g., phosphoric acid activated, lignocellulosic carbon precursors. The activated carbon materials surprisingly and unexpectedly demonstrate high surface area, high microporosity or high mesoporosity as well as reduced levels of impurities, e.g., phosphorus, as compared to untreated or conventional activated carbon materials.

Generally, the larger the surface area of the activated carbon, the greater its adsorption capacity. For example, the available surface area of activated carbon is dependent on its pore volume. Since the surface area per unit volume decreases as individual pore size increases, large surface area generally is maximized by maximizing the number of pores of very small dimensions and/or minimizing the number of pores of very large dimensions. Pore sizes are defined herein per IUPAC (International Union of Pure and Applied Chemistry) as micropores (pore width <2 nm), mesopores (pore width=2-50 nm), and macropores (pore width >50 nm, and nominally 50 nm-100 micrometers).

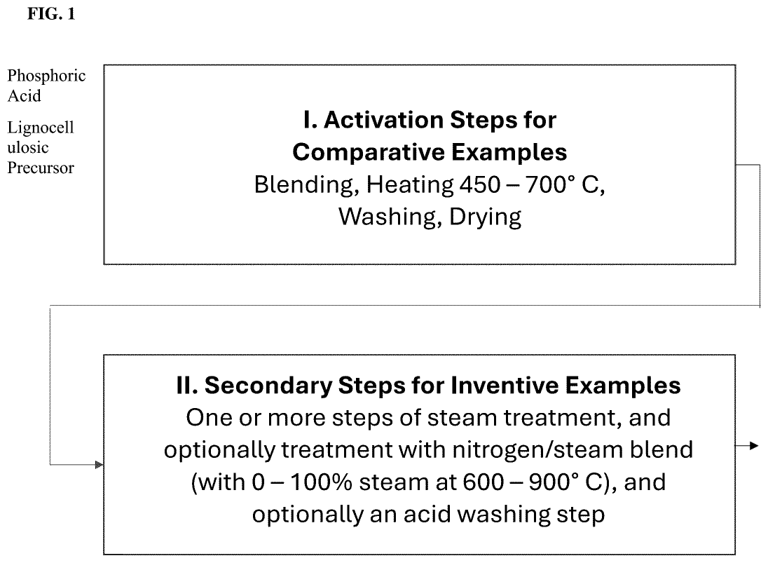

With reference to FIG. 1, in one aspect, the disclosure provides methods of making a reduced impurity, high surface area, chemically activated lignocellulosic carbon comprising the steps of providing a chemically activated carbon, e.g., as described in the 4th edition of the Kirk Othmer Encyclopedia of Chemical Technology (See FIG. 1(I) and description). For example, the material is blended and heated at a temperature of 450-700° C. for 0.5-3 hours, washed with water and dried to acceptable moisture levels.

In exemplary embodiments, the activated carbon material from FIG. 1(I) is subject to one or more secondary treatments (See FIG. 1(II) and description) including contacting with steam, and optionally nitrogen/steam blends (with, e.g., 0-100% steam) at a temperature of 600-900° C., and optionally an acid wash step, e.g., with an acid such as an organic or inorganic acid, e.g., gluconic acid, lactic acid, acetic acid, citric acid, nitric acid, phosphoric acid, hydrochloric acid, sulfuric acid, or the like and combinations thereof, to remove or reduce other impurities such as ash, iron, potassium, sulfur, calcium, sodium, zinc, phosphorus, silicon, copper, cobalt, aluminum, magnesium, nickel, chromium, barium, selenium, etc. or a combination thereof. The resulting chemically activated lignocellulosic carbon has desirable micro or mesoporosity, surface area, and reduced impurities, e.g., phosphorus, as compared to the initial activated carbon from (I).

In certain embodiments, the steam concentrations for the secondary treatment ranged from 0 to 100% at various points in the process and temperatures from about 600° C. to about 900° C. These steps brought P levels down from about 800-8000 ppm to below about 800 ppm based on Proton Induced X-ray Emission (PIXE) spectroscopy analysis.

The native, lignocellulosic carbon precursor (non-activated carbon) can be activated using a chemical activating agent. The chemical activating agent can be any generally known in the art or that become known to those of skill in the art. In any of the aspects or embodiments described herein, the chemical activating agent is selected from an acid, a base or a salt.

In any of the aspects or embodiments described herein, the chemical activating agent is at least one of phosphoric acid, sulfuric acid, boric acid, nitric acid, oxygenated acids, steam, air, peroxides, alkali hydroxides, potassium hydroxide, sodium hydroxide, sodium bicarbonate, potassium bicarbonate, urea, metal chlorides, calcium chloride, zinc chloride, ammonia, carbon dioxide, potassium carbonate or a combination thereof.

In certain embodiments, the chemical activating agent is applied to the lignocellulosic precursor at various ratios, which can impact the level of micro and mesoporosity. In any of the aspects or embodiments described herein, the chemical activating agent is phosphoric acid. In any of the aspects or embodiments described herein, the chemical activating agent is a solution of phosphoric acid with a concentration up to about 85%.

In any of the aspects or embodiments described herein, the activated lignocellulosic carbon comprises a lignocellulosic carbon precursor. Lignocellulosic carbon precursors may be generated from a variety of materials, including, e.g., peat, wood, wood dust, wood flour, cotton linters, nut shells or pits, carbohydrates, fruit pits or fruit stones, sawdust, palm, vegetables such as rice hull or straw, natural polymers, coconut shells or combinations thereof. In any of the aspects or embodiments described herein, the lignocellulosic carbon precursor is wood.

Comparative activated carbons include NUCHAR® activated carbons (Ingevity South Carolina, LLC, SC, USA), which is chemically activated carbon derived from wood and activated with phosphoric acid, as well as phosphoric acid, wood-based carbons from CECA and NORIT, and carbons described in Westvaco (former Ingevity) U.S. Pat. No. 6,060,424.

In certain embodiments, the amount of chemical activating agent is an effective amount, i.e., the amount necessary to achieve the desired ratio of micro- or mesoporosity, surface area, or a combination thereof, as described herein.

In any aspect or embodiment described herein, the method includes a final purification step comprising contacting with nitrogen, CO₂, O₂, and/or steam at temperature of from about 600 to 900° C.

In any aspect or embodiment described herein, an activated carbon is produced with at least one of: a BET surface area of greater than about 500 m²/g, and a micropore content, based on the ratio of total pore volume up to 2 nm/total pore volume up to 100 nm, of greater than about 50% (i.e., a micoporous carbon), or a micropore content based on total pore volume up to 2 nm/total pore volume up to 100 nm of less than about 50%, (i.e., a mesoporous carbon).

In any aspect or embodiment described herein, the chemically activated lignocellulosic carbon as described herein comprises a phosphorus (P) content of less than about 800 ppm as determined by PIXE, for example, below 800, 750, 700, 650, 600, 550, 500, 450, 400 ppm or less. This could be in combination with a low amount of other impurities, such as ash and transition metals such as iron, depending on the inclusion of an additional washing step with an acid, such as an organic or inorganic acid, e.g., sulfuric acid, nitric acid, hydrochloric acid, phosphoric acid, or an organic acid, e.g., citric acid, gluconic acid or the like.

Besides HCl, the effects of alternative organic and inorganic acids was also explored. Some of the exemplary acids include gluconic acid, lactic acid, acetic acid, citric acid, and phosphoric acid. Acid washing with these alternative acids allowed reduction of metallic impurities within similar range as HCl and also showed successful reduction in phosphorous in the final product

In any aspect or embodiment described herein, the phosphoric acid activated lignocellulosic carbon as described herein comprises recalcitrant forms of phosphorus that may include lower volatility inorganic phosphates such as tricalcium phosphate (Ca₃(PO₄)₂), hydroxyapatite (Cas(PO₄)₃ (OH)), and cation salts such as magnesium phosphate, aluminum phosphate, potassium phosphate, and sodium phosphate, higher volatility inorganic phosphates such as monosodium or disodium phosphate, covalently linked phosphorus including organophosphorus compounds or organophosphates, bulk and surface phosphorus, unreactive and reactive phosphorus, soluble and low solubility phosphorous compounds or a combination thereof.

Surprisingly following the heat treatment protocol described herein, phosphorous reduction below 800 ppm was possible even when the acid used for metal reduction of activated carbon was phosphoric acid. The result is shown in Table I below.

TABLE 1
Phosphorus content of phosphoric acid activated wood-based carbons
as determined by Proton Induced X-Ray Emission (PIXE), BET
Surface Area, and microporosity ratio via BJH analysis.

| | Micropore | BET | |
|---|---|---|---|
| | Volume/ | Surface | |
| | TPV ratio | Area | P content |
| Example | (%)* | (m²/g) | (ppm) |
| Comparative C1 | 18 | 1721 | 7825 |
| Comparative C2 | 21 | 1457 | 1710 |
| Comparative C3 | 97 | 1390 | 822 |
| Comparative C4 | 21 | 1591 | 4580 |
| Comparative C5 | 21 | 1656 | 8110 |
| Inventive I1 | 69 | 1401 | 357 |
| Inventive I2 | 67 | 1912 | 256 |
| Inventive I3 | 23 | 1323 | 436 |
| Inventive I4 | 68 | 1454 | 225 |
| Inventive I5 | 76 | 1554 | 277 |
| Inventive I6 | 74 | 1577 | 67 |
| Inventive I7 | 78 | 1375 | 163 |
| Inventive I8 | 79 | 1338 | 139 |
| Inventive I9 | 77 | 1398 | 211 |
| Inventive I10 | 77 | 1390 | 100 |

*As used herein, a microporous carbon has (micropore volume/total pore volume up to 100 nm (TPV)) × 100 > 50%; and a mesoporous carbon has (micropore volume/total pore volume up to 100 nm (TPV)) × 100 < 50%.

In any aspect or embodiment described herein, the chemical activation comprises phosphoric acid activation, wherein the activated lignocellulosic carbon as described herein comprises a P content of less than about 1000 ppm, 900 ppm, 800 ppm, 700 ppm, 600 ppm, 500 ppm, 400 ppm, 300 ppm, 200 ppm, 100 ppm or less as determined by Proton Induced X-ray Emission (PIXE) spectroscopy.

In any aspect or embodiment described herein, the phosphoric acid activated lignocellulosic carbon as described herein comprises a P content that is up to about 80% less than comparative carbons as determined by PIXE (See Table I).

In any aspect or embodiment described herein, the chemically activated, e.g., phosphoric acid activated, lignocellulosic carbon as described herein comprises reduced impurities, e.g., phosphorus, as compared to an initial (i.e., no secondary treatment) chemically activated carbon as determined by PIXE. In any aspect or embodiment described herein, the chemically activated, e.g., phosphoric acid activated, lignocellulosic carbon as described herein comprises a phosphorus content (i.e., “P content”) of less than about 1000 ppm, less than about 900 ppm, less than about 800 ppm, less than about 700 ppm, less than about 600 ppm, less than about 500 ppm, less than about 450 ppm, less than about 400 ppm, less than about 350 ppm, less than about 300 ppm, less than about 250 ppm, less than about 200 ppm, or from about 150 to about 500 ppm, or from about 200 to about 500 ppm, or from about 225 to about 500 ppm, or from about 250 to about 500 ppm, or from about 200 to about 450 ppm, or from about 200 to about 400 ppm, or from about 225 to about 400 ppm as determined by PIXE.

In any aspect or embodiment described herein, the phosphoric acid activated lignocellulosic carbon as described herein comprises a microporosity ratio (micropore volume/total pore volume up to 100 nm) of greater than 50, 55, 60, 70, 75, 80, 85, 90, 95% or more as determined by BJH Analysis.

In any aspect or embodiment described herein, the phosphoric acid activated lignocellulosic carbon as described herein comprises a microporosity ratio (micropore volume/total pore volume up to 100 nm) of less than 50, 45, 40, 35, 30, 25, 20, 15, 10, 5% or less as determined by BJH Analysis.

In any aspect or embodiment described herein, the chemically activated, e.g., phosphoric acid activated, lignocellulosic carbon as described herein comprises a nitrogen BET of from about 600 to about 3500 m²/g, from about 800 to about 3000 m²/g, or from about 1000 to about 2500 m²/g, a P content of from about 150 to about 800 ppm, or from about 200 to about 800 ppm, or from about 225 to about 800 ppm, or from about 250 to about 800 ppm, or from about 200 to about 500 ppm, or from about 200 to about 550 ppm, or from about 225 to about 600 ppm as determined by PIXE, and a microporosity ratio (based on total pore volume) of 5, 10, 15, 20, 25, 35, 35, 40, 45, 50, 55, 60, 70, 75, 80, 85, 90, 95% or more as determined by BJH Analysis. In certain embodiments, the microporosity ratio is from about 20% to less than 50%. In certain embodiments, the microporosity ratio is from greater than 50% to about 95%.

In any aspect or embodiment described herein, the chemically activated, e.g., phosphoric acid activated, lignocellulosic carbon as described herein comprises a nitrogen BET surface area of at least 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000 or more m²/g, including all values and ranges in between. In any aspect or embodiment described herein, the activated lignocellulosic adsorbent material has a nitrogen BET surface area from about 600 to about 3500 m²/g, from about 800 to about 3000 m²/g, or from about 1000 to about 2500 m²/g.

Activated carbons as described herein are suitable for use in a number of applications, including those requiring or necessitating low residual impurity levels, e.g., low residual P. Skilled artisans will readily appreciate that it is surprising and unexpected that chemically activated lignocellulosic-based activated carbons produced with phosphoric acid would be suitable for low P applications.

The low impurity, high surface area, high microporous and mesoporous chemically activated lignocellulosic carbon as described herein is not limited to any application. Non-limiting examples of applications for the structures disclosed herein include catalytic, filtration, antimicrobial, antifungal, photovoltaic, antifungal, chemisorption, antiviral, fabrics, ceramics, biotechnology, biomedical, fuel cell systems, semiconductors, micro-electronics, optics, gas storage applications, and energy storage applications

### EXAMPLES

The following examples serve to demonstrate exemplary embodiments of the invention as compared to currently available materials and is not limiting on the scope of the disclosure.

Comparative examples 1 and 2 are mesoporous commercially available phosphoric acid activated lignocellulosic carbons sold under the tradename Nuchar made by Ingevity. Comparative example 3 is a prior art phosphoric acid activated lignocellulosic microporous carbon as described in U.S. Pat. No. 6,060,424. Comparative example 4 is a mesoporous phosphoric acid activated lignocellulosic carbon sold under the tradename ENO (made by CECA Specialty Chemicals), and Comparative example 5 is a mesoporous phosphoric acid activated lignocellulosic carbon sold under the tradename CA made by Norit Activated Carbon. All five carbons have P levels in excess of 800 ppm by PIXE analysis.

The additional steps for Inventive Example I included the use of steam up to 100% at temperatures up to about 760° C. for a total of up to about 11.5 hours along with an HCl acid washing step.

The additional steps for Inventive Example 2 included the use of steam up to 100% at temperatures up to about 850° C. for a total of up to about 4.5 hours along with an HCl acid washing step.

The additional steps for Inventive Example 3 included the use of steam up to 100% at temperatures up to about 650° C. for a total of up to about 15 hours.

The additional steps for Inventive Example 4 included the use of steam up to 100% at temperatures up to about 850° C. for a total of up to about 11 hours along with an HCl acid washing step.

The additional steps for Inventive Example 5 included the use of steam up to 100% at temperatures up to about 850° C. for a total of up to about 4.2 hours, along with a H3PO4 acid washing step.

The additional steps for Inventive Example 6 included the use of steam up to 100% at temperatures up to about 850° C. for a total of up to about 22 hours, along with a HCl acid washing step.

The additional steps for Inventive Example 7 included the use of steam up to 100% at temperatures up to about 850° C. for a total of up to about 20.75 hours, along with a Gluconic acid washing step.

The additional steps for Inventive Example 8 included the use of steam up to 100% at temperatures up to about 850° C. for a total of up to about 20.75 hours, along with a Lactic acid washing step.

The additional steps for Inventive Example 9 included the use of steam up to 100% at temperatures up to about 850° C. for a total of up to about 20.75 hours, along with a Citric acid washing step.

The additional steps for Inventive Example 10 included the use of steam up to 100% at temperatures up to about 850° C. for a total of up to about 20.75 hours, along with a Acetic acid washing step.

Exemplary low impurity, high surface area, and high meso and microporous activated carbon materials as described herein are provided in Table I and are compared to certain commercially available phosphoric acid lignocellulosic activated carbon materials and prior art phosphoric acid lignocellulosic activated carbon materials. The phosphorus content of phosphoric acid activated wood-based carbons was determined by Proton Induced X-Ray Emission (PIXE), BET Surface Area, and microporosity ratio via BJH analysis.

### Exemplary Methods

### Proton Induced X-Ray Emission (PIXE) Spectroscopy

PIXE is an exemplary technique used for determining the elemental composition of a material or sample. PIXE measures X-rays emitted from a sample due to high-energy ion bombardment. Several kinds of excitation beams produce X-rays with energies characteristic of the target elements. Photon excitation (by X-rays) gives rise to X-ray fluorescence spectroscopy. Electron excitation in a scanning electron microscope or an electron microprobe provides energy dispersive or wavelength dispersive X-ray spectroscopy (depending on the X-ray dispersion and detection method). Charged particle beams of He²⁺ or H⁺ lead to PIXE spectroscopy. In all three cases, the excitation beam removes a core electron, and X-rays are emitted with specific energies when outer shell electrons change state to fill the inner shell vacancy. The X-ray energies emitted are independent of the excitation process but are characteristic of the elements present. See, e.g., Ishii. K. PIXE and Its Applications to Elemental Analysis. Quantum Beam Science. 3 (2): 1-14 (2019).

PIXE has several advantages as an analytic technique. It is non-destructive and offers signal levels similar to its electron beam counterparts, but it has better signal-to-background ratios. The background in electron spectroscopy arises from bremsstrahlung, which is largely absent because He²⁺ or H⁺ ions, even at PIXE energies, have much lower velocities than electrons. Another advantage over electron induced spectroscopy is that PIXE works with insulating samples.

### BET Surface Area

Surface areas were measured by nitrogen physisorption using the by the Brunauer-Emmet-Teller (BET) method according to ISO 9277:2010 in a Micromeritics ASAP 2420 (Norcross, GA). The sample preparation procedure was to degas at 250° C. for at least two hours, typically to a stable <2 μm Hg vacuum with the sample isolated. The nitrogen adsorption isotherm was recorded at 77 K for a 0.1 g sample, targeting the following pressures: 0.04, 0.05, 0.085, 0.125, 0.15, 0.18, 0.2, 0.355, 0.5, 0.63, 0.77, 0.9, 0.95, 0.995, 0.95, 0.9, 0.8, 0.7, 0.6, 0.5, 0.45, 0.4, 0.35, 0.3, 0.25, 0.2, 0.15, 0.12, 0.1, 0.07, 0.05, 0.03, 0.01. Actual points were recorded within an absolute or relative pressure tolerance of 5 mmHg or 5%, respectively, whichever was more stringent. Time between successive pressure readings during equilibration was 10 seconds. The non-ideality factor was 0.0000620. The density conversion factor was 0.0015468. The thermal transpiration hard-sphere diameter was 3.860 Å. The molecular cross-sectional area was 0.162 nm². The data in the range of 0.05 to 0.20 relative pressure of the nitrogen adsorption isotherm was used to apply the BET model.

### Determination of Pore Volumes

Volume of pores (PV)<1.8 nm to 100 nm in size was measured by nitrogen adsorption porosimetry by the nitrogen gas adsorption method ISO 15901-2:2006 using a Micromeritics ASAP 2420 (Norcross, GA). The sample preparation procedure for nitrogen adsorption testing was to degas at 250 C for at least two hours, typically to a stable <2 μm Hg vacuum with the sample isolated. The determination of pore volumes for pores <1.8 nm to 100 nm in size was from the desorption branch of the 77 K isotherm for a 0.1 g sample. The nitrogen adsorption isotherm data was analyzed by the Kelvin and Halsey equations to determine the distribution of pore volume with pore size of cylindrical pores according to the model of Barrett, Joyner, and Halenda (“BJH”). The non-ideality factor was 0.0000620. The density conversion factor was 0.0015468. The thermal transpiration hard-sphere diameter was 3.860 Å. The molecular cross-sectional area was 0.162 nm². The condensed layer thickness (Å) related to pore diameter (D, Å) used for the calculations was 0.4977 [In (D)] 2-0.6981 In (D)+2.5074. Target relative pressures for the isotherm were the following: 0.04, 0.05, 0.085, 0.125, 0.15, 0.18, 0.2, 0.355, 0.5, 0.63, 0.77, 0.9, 0.95, 0.995, 0.95, 0.9, 0.8, 0.7, 0.6, 0.5, 0.45, 0.4, 0.35, 0.3, 0.25, 0.2, 0.15, 0.12, 0.1, 0.07, 0.05, 0.03, 0.01. Actual points were recorded within an absolute or relative pressure tolerance of 5 mmHg or 5%, respectively, whichever was more stringent. Time between successive pressure readings during equilibration was 10 seconds.

What is claimed is:

1. An activated lignocellulosic carbon material comprising a chemically activated lignocellulosic carbon, wherein the chemically activated lignocellulosic carbon is treated with at least one of an acid wash, a heat treatment or combination thereof, thereby having a reduced impurity level as compared to an untreated activated carbon.

2. The activated lignocellulosic carbon material of claim 1, wherein the impurity comprises at least one of ash, iron, potassium, sulfur, calcium, sodium, zinc, phosphorus, silicon, copper, cobalt, aluminum, magnesium, nickel, chromium, barium, selenium, or a combination thereof.

3. The activated lignocellulosic carbon material of claim 2, wherein the chemically activated lignocellulosic carbon has a reduction in the amount of phosphorus as compared to untreated activated carbon.

4. The activated lignocellulosic carbon material of claim 3, wherein the chemically activated lignocellulosic carbon has a phosphorus content of less than about 800 ppm.

5. The activated lignocellulosic carbon material of claim 1, wherein the chemically activated lignocellulosic carbon has a ratio of micropore volume to total pore volume ratio of at least 50%.

6. The activated lignocellulosic carbon of claim 1, wherein the chemically activated lignocellulosic carbon has a ratio of micropore volume to total pore volume ratio of less than 50%.

7. The activated lignocellulosic carbon of claim 1, wherein the chemically activated lignocellulosic carbon has a has a BET surface of at least 1200 m²/g.

8. The activated lignocellulosic carbon of claim 7, wherein the chemically activated lignocellulosic carbon has a BET surface of at least 1300 m²/g.

9. The activated lignocellulosic carbon of claim 1, wherein the chemically activated lignocellulosic carbon is activated by phosphoric acid.

10. The activated lignocellulosic carbon of claim 1, wherein the lignocellulosic carbon comprises at least one of peat, wood, wood dust, wood flour, cotton linters, nut shells or pits, carbohydrates, fruit pits or fruit stones, sawdust, palm, vegetables such as rice hull or straw, natural polymers, coconut shells or combinations thereof.

11. The activated lignocellulosic carbon of claim 10, wherein the lignocellulosic carbon comprises wood or sawdust or both.

12. The activated lignocellulosic carbon of claim 5, wherein the chemically activated lignocellulosic carbon comprises a micropore volume, based on the total pore volume, of more than 60%.

13. An activated lignocellulosic carbon material comprising a chemically activated lignocellulosic carbon wherein the chemically activated lignocellulosic carbon has less than about 800 ppm of phosphorus.

14. The activated lignocellulosic carbon material of claim 13, wherein the chemically activated lignocellulosic carbon is treated with at least one of an acid wash, a heat treatment or combination thereof, thereby having a reduced impurity level as compared to an untreated activated carbon.

15. The activated lignocellulosic carbon material of claim 14, wherein the impurity is at least one of ash, iron, potassium, sulfur, calcium, sodium, zinc, silicon, copper, cobalt, aluminum, magnesium, nickel, chromium, barium, selenium, or a combination thereof as compared to untreated activated carbon.

16. The activated lignocellulosic carbon material of claim 13, wherein the chemically activated lignocellulosic carbon has a ratio of micropore volume to total pore volume ratio of at least 50%.

17. The activated lignocellulosic carbon material of claim 13, wherein the chemically activated lignocellulosic carbon has a has a BET surface of at least 1200 m²/g.

18. The activated lignocellulosic carbon material of claim 17, wherein the chemically activated lignocellulosic carbon has a BET surface of at least 1300 m²/g.

19. The activated lignocellulosic carbon material of claim 13, wherein the chemically activated lignocellulosic carbon is activated by phosphoric acid.

20. The activated lignocellulosic carbon material of claim 13, wherein the lignocellulosic carbon comprises at least one of peat, wood, wood dust, wood flour, cotton linters, nut shells or pits, carbohydrates, fruit pits or fruit stones, sawdust, palm, vegetables such as rice hull or straw, natural polymers, coconut shells or combinations thereof.

21. The activated lignocellulosic carbon material of claim 20, wherein the lignocellulosic carbon comprises wood or sawdust or both.

22. The activated lignocellulosic carbon material of claim 13, wherein the chemically activated lignocellulosic carbon comprises a ratio of micropore volume to total pore volume ratio of less than about 50%.

23. The activated lignocellulosic carbon of claim 13, wherein the chemically activated lignocellulosic carbon comprises a micropore volume, based on the total pore volume, of more than 60%.

24. A chemically activated lignocellulosic carbon material comprising a chemically activated lignocellulosic carbon having at least one of a Brunauer-Emmet-Teller (BET) surface area of at least 500 m²/g, a ratio of micropore volume to total pore volume ratio of at least 50%, a ratio of micropore volume to total pore volume ratio of less than 50% or a combination thereof, wherein the chemically activated lignocellulosic carbon is treated with an acid wash or heat, thereby having a reduced impurity level as compared to an untreated activated carbon.

25. The activated lignocellulosic carbon material of claim 24, wherein the impurity is at least one of ash, iron, potassium, phosphorus, sulfur, calcium, sodium, zinc, silicon, copper, cobalt, aluminum, magnesium, nickel, chromium, barium, selenium, or a combination thereof as compared to untreated activated carbon.

26. The chemically activated lignocellulosic carbon material of claim 25, wherein the chemically activated lignocellulosic carbon has a phosphorus content of less than about 500 ppm.

27. The chemically activated lignocellulosic carbon material of claim 24, wherein the chemically activated lignocellulosic carbon has a BET surface of at least 1300 m²/g.

28. The chemically activated lignocellulosic carbon material of claim 24, wherein the chemically activated lignocellulosic carbon comprises a micropore volume, based on the total pore volume, of more than 60%.
